(19) United States
(12) Patent Application Publication
(10) Pub. No.: US 2025/0168918 A1
(43) Pub. Date: May 22, 2025

(54) ENHANCED MECHANISM ON UU INTERFACE FOR MT SDT

(71) Applicant: Lenovo (Beijing) Limited, Beijing (CN)

(72) Inventors: Ran Yue, Beijing (CN); Lianhai Wu, Beijing (CN); Jing Han, Beijing (CN); Haiming Wang, Beijing (CN); Jie Hu, Beijing (CN)

(73) Assignee: Lenovo (Beijing) Limited, Beijing (CN)

(21) Appl. No.: 18/722,082

(22) PCT Filed: Dec. 21, 2021
(86) PCT No.: PCT/CN2021/140159

§ 371 Date: Jun. 20, 2024

(51) Int. Cl. H04W 76/27; H04W 68/02; H04W 74/0833

(52) U.S. Cl. CPC H04W 76/27; H04W 68/02; H04W 74/0833

(57) ABSTRACT

Methods and apparatuses for MT SDT are disclosed. A terminal device comprises a processor; and a transceiver coupled to the processor, wherein the processor is configured to receive, via the transceiver upon the terminal device being in an Radio Resource Control (RRC) non-CONNECTED state with a network device, a message for Mobile Terminating (MT) Small Data Transmission (SDT) from the network device; and determine a DL data receiving procedure for MT SDT according to the message for MT SDT.

### FIELD

The subject matter disclosed herein generally relates to wireless communications, and more particularly relates to methods and apparatuses for MT SDT.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), small data transmission (SDT), configured grant (CG), CG based SDT (CG-SDT), random access channel (RACH), RACH based SDT (RA-SDT), Reference Signal Received Power (RSRP), Mobile originate (MO), Mobile terminated (MT), radio access network (RAN), 5G core (5GC), physical random access channel (PRACH), time alignment or timing advance or timing adjustment (TA), TA timer (TAT), timing advance group (TAG), primary TAG (PTAG), secondary TAG (STAG), Transmit-Receive Point (TRP), Physical Uplink Control Channel (PUCCH), Physical Uplink Shared Channel (PUSCH), time division multiplexing (TDM), control resource set (CORESET), reference signal (RS), inter-cell beam management (ICBM), Multiple-Input Multiple-Output (MIMO), Data Resource Bearer (DRB), Signal Resource bearer (SRB), Earthquake and Tsunami Warning System (ETWS), Commercial Mobile Alert System (CMAS), Radio Network Temporary Identifier (RNTI), Paging RNTI (P-RNTI), Physical Downlink Control Channel (PDCCH), Paging Control Channel (PCCH), Cyclic Redundancy Check (CRC), Reference Signal Received Power (RSRP), Information Element (IE), Access Stratum (AS), Packet Data Convergence Protocol (PDCP).

There are two RRC states for 4G LTE: RRC_IDLE and RRC_CONNECTED. 5G NR introduces a new RRC state, RRC_INACTIVE. Therefore, in 5G NR, RRC has three distinct states: RRC_IDLE, RRC_CONNECTED and RRC_INACTIVE.

RRC_IDLE: Upon power on, UE enters into RRC_IDLE state. UE may move to this state from either RRC_CONNECTED state or RRC_INACTIVE state.

RRC_INACTIVE: UE moves to this state from RRC_CONNECTED state. It is connected but inactive state of UE. In this state, UE maintains RRC connection and at the same time minimizes signaling and power consumption.

RRC_CONNECTED: UE remains in connection with the 5G-RAN and 5GC in this state.

RRC states transition process is shown in FIG. 1.

The main principle of the RRC_INACTIVE state is that the UE is able to return to the RRC_CONNECTED state as quickly and efficiently as possible. When the UE transforms to RRC_INACTIVE state, both the UE and the RAN store all the information necessary to quickly resume to RRC_CONNECTED state.

An UE in RRC_INACTIVE state may initiate a resume procedure when there is a need to transmit data or signaling. In this case, the UE transmits an RRC resume request that includes the UE identifier and a security token to verify the legitimacy of the resume request. After the UE configuration is successfully retrieved, the target node (e.g. the base station that receive the RRC resume request) resumes the stored configuration at the UE and applies any necessary modifications, such as the configuration of measurements and the addition or removal of bearers. The respective RRC resume message is integrity protected and encrypted using the security context stored in the network and the UE.

In the RRC_INACTIVE state, the UE is in a power-saving sleep state, but it still retains part of the RAN context (security context, UE capability information, etc.), and can be quickly awakened by a message to transfer from the RRC_INACTIVE state to the RRC_CONNECTED state. NR Release 17 supports direct transmission of small data transmission (SDT) in the RRC_INACTIVE state.

A current SDT procedure is described as follows.

A SDT configuration (e.g. CG based SDT (CG-SDT) configuration) has been configured to the UE when the UE is released to RRC_INACTIVE state. Several CG occasions for SDT (e.g. CG resources) are configured in the CG-SDT configuration. Alternatively, several CG configurations for SDT are configured. When SDT data arrives, the UE initiates the selection between SDT and non-SDT, also between CG-SDT procedure and RACH based SDT (RA-SDT) procedure if SDT is selected. In particular, if CG-SDT criteria are met, UE selects CG-SDT and initiate SDT procedure; else if RA-SDT criteria are met: UE selects RA-SDT and initiate SDT procedure; else, UE initiates non-SDT procedure. CG-SDT criteria are considered met, if 1) available data volume <=data volume threshold and 2) RSRP is greater than or equal to a configured threshold. RA-SDT criteria is considered met, if 1) available data volume <=data volume threshold; 2) RSRP is greater than or equal to a configured threshold; and 3) 4 step RA-SDT resources are configured on the selected UL carrier and criteria to select 4 step RA-SDT is met; or 2 step RA-SDT resources are configured on the selected UL carrier and criteria to select 2 step RA-SDT is met.

A 4 step RACH procedure (that can be used as RA-SDT) comprises: UE transmits a preamble (Msg1) on PRACH to a network device (e.g. gNB)); the network device transmits a response (Msg2) to the preamble); the UE transmits uplink information (Msg3) according to the response; and the network device transmits a contention resolution message (Msg4) according to the uplink information. A 2-step RACH procedure (that can be used as RA-SDT) comprises the transmission of MsgA and MsgB, wherein MsgA corresponds to a combination of Msg1 and Msg3 and MsgB corresponds to a combination of Msg2 and Msg4. It can be seen that RA-SDT (4-step RA-SDT or 2-step RA-SDT) allows SDT to use an uplink grant received via a random access procedure for SDT.

On the other hand, CG-SDT allows SDT to use a configured grant without performing a random access procedure.

The above-described SDT (e.g. RA-SDT and CG-SDT) can be referred to as UL (uplink) SDT. In addition, the above-described SDT is initiated by the UE, which can be referred to as MO (Mobile originate) SDT.

In the MO SDT initiated by the UE, a network device (e.g. gNB) can also transmit DL data (e.g. small data). Such DL small data transmission can be referred to as DL SDT. In addition, SDT can be initiated by the network device (e.g. gNB). The SDT that is initiated by the gNB is referred to as MT (Mobile terminated) SDT.

An MT SDT procedure is initiated by the network device (e.g. gNB) for a downlink (DL) data transmission.

TA, which can represent time alignment or timing advance or timing adjustment, is used to adjust the uplink frame timing relative to the downlink frame timing. A TA value, which can be the amount of timing adjustment, depends on the propaganda delay of the signal from the gNB to the UE. So, different UEs have different TAs relative to the gNB.

Traditionally, a UE can be served by a plurality of serving cells. Among the plurality of serving cells, a group of cells, when configured with UL transmission, using the same timing reference cell and the same TA value, belong to a timing advance group (TAG). The TAG containing the SpCell is referred to as primary TAG (PTAG), while each of other TAGs is referred to as secondary TAG (STAG).

A cell may have multiple (e.g. two) TRPs. A UE may transmit UL signals (e.g. PUSCH transmission and/or PUCCH transmission) to multiple TRPs. In NR Release 17, the multiple TRPs are limited to two TRPs. In addition, the UE may only transmit UL signals, e.g. with two panels of the UE, to two TRPs in a TDM manner (i.e. asynchronously, instead of simultaneously).

To extend the cell coverage, multiple TRPs are likely to be put in different locations within the cell. In this condition, the TA from a UE to one of multiple TRPs and the TA from the UE to another of the multiple TRPs (e.g. two TRPs) will be different significantly. It means that, the UE should transmit a UL signal to one TRP of a cell by using one TA and transmit the same UL signal or another UL signal to another TRP of the cell by using another TA.

So, the UE needs to manage at least two TAs for a cell having multiple (e.g. two) TRPs that are located differently. When the UE transmits UL signals to multiple (e.g. two) TRPs of a cell, the UE generally has multiple (e.g. two) panels, each of which is used to transmit UL signal to a different TRP. This can be referred to as multi-panel multi-TRP scenario.

A link is defined so that that a different link is associated with a different TA. A link can be indicated as from a panel to a TRP. Multiple beams are sent from a panel. In addition, multiple beams used for receiving belong to a TRP. Accordingly, a beam or a beam set (or beam group) consisting of multiple beams may alternatively indicate a link.

As a whole, for a UE in multi-panel multi-TRP scenario and served by multiple serving cells, beam configurations are related to how the signals are transmitted between the UE and the base station, e.g. a link is established between which panel of the UE and which TRP of which cell. Each link is associated with a TA. Different links may be associated with different TAs or the same TA.

The configurations of inter-cell beam management (ICBM) (i.e. beam configurations) could be added to the configuration of the serving cell (e.g. ServingCellConfig).

This invention targets the issues related to MT SDT, e.g. the responding procedure, the resuming occasion of SDT resources, and the configurations (e.g. beam configurations) to be resumed.

### BRIEF SUMMARY

Methods and apparatuses for MT SDT are disclosed.

In one embodiment, a terminal device that supports an Radio Resource Control (RRC) non-CONNECTED state with a network device comprises a processor; and a transceiver coupled to the processor, wherein the processor is configured to receive, via the transceiver, a message for Mobile Terminating (MT) Small Data Transmission (SDT) from the network device; and determine DL data receiving procedure for MT SDT according to the message for MT SDT.

In one embodiment, the message includes at least one of an intention indication, a responding indication and a DL data size indication, wherein the intention indication indicates that the intention of the message is MT SDT, the responding indication indicates the procedure that can be used for responding to the paging for MT-SDT, the DL data size indication indicates at least one of (1) DL data size, (2) an RSRP threshold, (3) whether the data size is larger or smaller than a data size threshold, and (4) the DL data is one-shot transmission or multiple-shot transmission. In another embodiment, the message is one of a paging message, a short message, a short message indicator, a new broadcast message, a new RRC message and a new message on Uu interface.

In one embodiment, one of an RA-SDT, an CG-SDT and a legacy RACH procedure is determined as the DL data receiving procedure for MT SDT. In another embodiment, determining the DL data receiving procedure for MT SDT further comprises determining resuming occasion and/or resumed configurations.

In some embodiment, the resuming occasion is one of: upon the message for MT SDT is received; upon UL responding procedure is initiated; upon UL responding message is transmitted; after RRC resume request message has been successfully received; and after UL transmission on PUSCH has been confirmed. The resumed configurations includes beam configurations, and the beam configurations are resumed according to configuration contained in the message for MT SDT from the network device, or the beam configurations are not allowed to be resumed. In some embodiment, only the beam configurations associated with non-expired TATs can be resumed. In some embodiment, the resumed configurations may include beam configurations, where the beam configurations are released when a neighboring cell is reselected to respond to the MT SDT

In one embodiment, a network device comprises a processor; and a transceiver coupled to the processor, wherein the processor is configured to transmit, via the transceiver, a message for Mobile Terminating (MT) Small Data Transmission (SDT) to a terminal device in an Radio Resource Control (RRC) non-CONNECTED state; and receive, via the transceiver, a UL message to indicate DL data receiving procedure for MT SDT.

In another embodiment, a method performed by a terminal device in an Radio Resource Control (RRC) non-CONNECTED state with a network device comprises receiving a message for Mobile Terminating (MT) Small Data Transmission (SDT) from the network device; and determining DL data receiving procedure for MT SDT according to the message for MT SDT.

In yet another embodiment, a method may be performed by a network device and comprise transmitting a message for Mobile Terminating (MT) Small Data Transmission (SDT) to a terminal device in an Radio Resource Control (RRC) non-CONNECTED state with the network device; and receiving a UL message to indicate DL data receiving procedure for MT SDT.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates RRC states in NR;

FIG. 2 is a schematic flow chart diagram illustrating an embodiment of a method;

FIG. 3 is a schematic flow chart diagram illustrating a further embodiment of a method; and

FIG. 4 is a schematic block diagram illustrating apparatuses according to one embodiment.

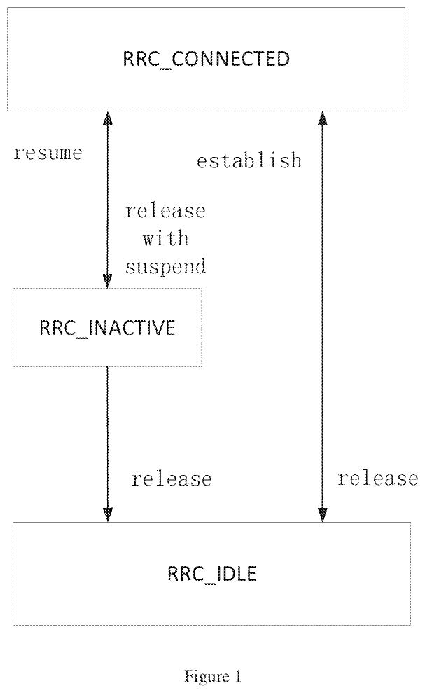

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

SDT can be supported not only in RRC_INACTIVE state but also in RRC_IDLE state. The RRC_INACTIVE state and the RRC_IDLE state can be collectively referred to as RRC non-CONNECTED state. All of the embodiments apply to a terminal device (e.g. UE) in RRC non-CONNECTED state.

In the following description, “paging for MT-SDT” means a message or an indication for the upcoming DL-triggered small data transmission. The name of the expression “paging for MT-SDT” may be replaced with other name(s). However, the meaning of the expression does not change.

The base station (e.g. gNB) (which can also be referred to as BS, network device, network node, etc) may transmit the paging for MT-SDT to the UE when downlink (DL) data arrives at the gNB and the size of the DL data meets certain criteria (e.g. the size of the DL data is smaller than a pre-defined threshold. When the paging for MT-SDT is received by a UE in RRC non-CONNECTED (e.g. RRC_IDLE or RRC_INACTIVE) state, the UE is expected to receive the data as SDT without transiting to RRC_CONNECTED state.

In a first embodiment, it is assumed that the UE is in RRC non-CONNECTED state and is configured with SDT (e.g. the UE is configured with SDT DRBs and/or SDT SRBs and/or resources for SDT).

The paging for MT-SDT received by the UE can be contained in a message. The message can be a paging message, a short message, a short messages indicator, or a new broadcast message or a new RRC message or a new message on Uu interface.

Paging allows the network to reach UE(s) in RRC_IDLE and in RRC_INACTIVE state through paging messages, and to notify UE(s) in RRC_IDLE, RRC_INACTIVE and RRC_CONNECTED state of system information change and ETWS or CMAS indications through short messages. Both paging messages and short messages are addressed with P-RNTI on PDCCH, but while the former (paging message) is sent on PCCH, the latter (short messages) is sent over PDCCH directly.

Short Messages can be transmitted on PDCCH using P-RNTI with or without associated Paging message using Short Message field in DCI format 1_0.

In particular, the following information is transmitted by means of the DCI format 1_0 with CRC scrambled by P-RNTI: Short Messages Indicator (2 bits), Short Messages (8 bits), etc.

The paging for MT-SDT includes at least one of the following indications:

(1) An intention indication, to indicate that the intention or cause of the paging for MT-SDT is DL data arrival which can be transmitted as SDT, for example, MT SDT.

(2) A responding indication, to indicate the procedure that can be used for responding to the paging for MT-SDT. In a first example, the responding indication can indicate that UE shall respond with which one of an RA-SDT, an CG-SDT and a legacy RACH procedure. In addition, in the first example, the responding indication can provide an additional choice that is up to the UE implementation to determine with which procedure to respond to the paging for MT-SDT. The indication for up to UE implementation can be explicit or implicit. For example, when the responding indication is absent, it implicitly means up to UE implementation. In a second example, the responding indication can indicate whether to allow the UE to respond with CG-SDT. For example, a new IE can be used to indicate whether to allow the UE to respond with CG-SDT. The responding indication can be specified or pre-defined to, for example, ‘allow’. That is, an absent responding indication implies that the UE is allowed to respond with CG-SDT. Alternatively, the responding indication can explicitly indicate ‘allow’ or ‘not allow’.

(3) A DL data size indication. The DL data size indication may include at least one of the following information: (3-1) the DL data size; (3-2) the DL data size (or the DL data volume) is larger or smaller than a data size threshold; (3-3) a RSRP threshold (T1), where the UE can compare the UE's RSRP with the RSRP threshold; (3-4) the DL data is one-shot transmission or multiple-shot transmission.

Upon receiving the message including the paging for MT-SDT, the UE can determine how to respond to the paging for MT-SDT according to the indications contained in the paging for MT-SDT. For example, the UE determines which procedure is used to respond to the paging for MT-SDT, for example, an MO SDT procedure (e.g. RA-SDT or CG-SDT) or a legacy RACH procedure can be used to respond to the paging for MT-SDT. Upon the UE initiating a procedure to respond to the paging for MT-SDT, the resume cause is set to MT-SDT.

The UE also determines the resuming occasion (will be discussed in a second embodiment), at which the configured SDT DRBs and/or SDT SRBs and/or resources for SDT are resumed, and/or part or all of the UE Inactive AS context is restored (for example, restore the RRC configuration, RoHC state, the stored QoS flow to DRB mapping rules and the K_{gNB} and K_{RRCint} keys from the stored UE Inactive AS context), and/or PDCP entities for SRB1 are re-established, and/or determines how the configurations (e.g. beam configurations) stored when transiting to RRC non-CONNECTED state are resumed (will be discussed in a third embodiment).

The second embodiment relates to the resuming occasion.

According to the second embodiment, the UE determines the resuming occasion. Different occasion candidates are provided:
Occasion candidate 1: When the message (e.g. “paging for MT-SDT”) is received by the UE. Occasion candidate 1 applies to all potential responding procedures (e.g. MO SDT procedure or a legacy RACH procedure).
Occasion candidate 2: After the RRC resume request message has been successfully received by the gNB. For example, after the contention resolution by the UE succeeds, or after the UL transmission on PUSCH by the UE has been confirmed. Occasion candidate 2 applies to all potential responding procedures.
Occasion candidate 3: Upon initiating UL responding procedure. For example, the resuming occasion is upon initiating RRC resume procedure for SDT initiation when MO SDT (e.g. RA-SDT or CG-SDT) is used as UL responding procedure. For another example, the resuming occasion is upon initiating RRC resume procedure if the legacy RACH procedure is used to responds to “paging for MT-SDT”.
Occasion candidate 4: Upon UL responding message is transmitted.
Occasion candidate 5: after UL transmission on PUSCH has been confirmed.

A third embodiment relates to the beam configurations.

In the third embodiment, it is assumed that the UE is configured with beam configurations. The beam configurations may include but not limited to at least one of beam-based inter-cell configuration, multi-TRP configuration, multi-panel configuration, and MIMO configuration. In addition, other configurations are also possible. For example, a panel corresponds to a set of reference signals (RSs) (maybe referred to as RS set). So, the beam configurations may also include RS set configuration. For another example, a TRP corresponds to a pool of CORESETs with the same CORESETPoolIndex. So, the beam configurations may also include CORESET pool configuration. In addition, the UE is configured with SDT (e.g. the UE is configured with SDT DRBs and/or SDT SRBs and/or resources for SDT). When the UE is transited to RRC non-CONNECTED state, the UE has stored the beam configurations.

When the UE in the RRC non-CONNECTED state receives paging for MT-SDT, the UE determines whether to resume (i.e. restore) the stored beam configurations according to any of the following options:

Option 1: the gNB that manages the cell from which the paging for MT-SDT is transmitted can configure the UE to resume the stored beam configurations. If the gNB that manages the cell from which the paging for MT-SDT is transmitted does not configure the UE to resume the stored beam configurations, the UE releases the stored beam configurations. To “resume” the stored beam configurations means to “restore” or to “use” the stored beam configurations.

Option 2: the UE is not allowed to (i.e. does not) resume the stored beam configurations. For example, it can be specified that the UE is not allowed to resume the stored beam configurations; or it is a default configuration that the UE is not allowed to resume the stored beam configurations; or it is predefined that the UE is not allowed to resume the stored beam configurations. “The UE is not allowed” to resume the stored beam configurations means that “the UE is forbidden” to resume the stored ICBM configuration.

Option 3: the UE determines whether to resume the stored beam configurations according to an RSRP threshold and/or a data size threshold. For example, if the UE's RSRP is greater than a first threshold (T1) and/or the data size for the MT SDT is smaller than a second threshold (T2), only some of the beam configurations are resumed. For example, if the beam configurations include multi-TRP configuration or multi-panel configuration or multi-beam configuration, only one-TRP configuration or one-panel configuration or one-beam configuration can be resumed. Otherwise, for example, if the UE's RSRP is smaller than the first threshold (T1) and/or the data size for the MT-SDT is greater than the second threshold (T2), all of the stored beam configurations are resumed. Incidentally, the RSRP threshold can be included in the DL data size indication. If the data size for the MT SDT is included in the DL data size indication, the data size threshold, i.e. the second threshold (T2), can be a predefined value. Alternatively, the DL data size indication may include whether the data size for the MT SDT is smaller or larger than the second threshold (T2).

If the UE reselects a neighboring cell and initiates a responding procedure using the neighboring cell, the UE releases all of the stored beam configurations. If the UE reselects a neighboring cell but does not initiate a responding procedure using the neighboring cell, the UE neither resumes nor releases the stored beam configurations. It means that the beam configurations are still stored.

Each beam is associated with a TA, and each TA is associated with a TA timer (TAT). When a TAT expires, the beam configuration related to the beam associated with the TAT, i.e. associated with the TA associated with the TAT, is released by the UE. It means that when all of part of the beam configurations are resumed, only the beam configuration(s) that are associated with non-expired TATs can be resumed. Alternatively, when the TAT expires, the beam configuration related to the beam associated with the TAT is neither resumed nor released (which implies that the beam configuration related to the beam associated with the expired TAT is still stored, and can be reused when the TAT is re-running).

A fourth embodiment relates to the beam configurations without SDT.

In the fourth embodiment, it is assumed that the UE is configured with beam configurations.

If the beam configurations are allowed to be stored in the UE when the UE transits to RRC non-CONNECTED state, the serving cell that releases the UE to RRC non-CONNECTED state indicates the UE's state transition (e.g. from RRC CONNECTED state to RRC non-CONNECTED state) to neighboring cell(s). It means that the information interaction between the cells can be performed within the gNB (if the serving cell and the neighboring cell(s) belong to the same gNB) or between the gNBs (if the serving cell and the neighboring cell(s) belong to different gNBs).

If the beam configurations are allowed to be stored in the UE when the UE transits to RRC non-CONNECTED state, the UE stores the beam configurations when it is released to RRC non-CONNECTED state. Otherwise (i.e. when the beam configurations are not allowed to be stored in the UE when the UE transits to RRC non-CONNECTED state), the UE releases the beam configurations when it is released to RRC non-CONNECTED state.

When the UE is resumed to RRC CONNECTED state, the UE applies the stored beam configurations (if stored) or default beam configurations (if the default beam configurations are configured). The stored or default beam configurations can be applied when RRC connection is initiated.

If the UE reselects a neighboring cell and initiates a responding procedure (e.g. RRC procedure) using the neighboring cell, the UE releases all of the stored beam configurations. If the UE reselects a neighboring cellbut does not initiate a responding procedure using the neighboring cell, the UE neither resumes nor releases the stored beam configurations. It means that the beam configurations are still stored.

When a TAT expires, the beam configuration related to the beam associated with the TAT, i.e. associated with the TA associated with the TAT, is released by the UE. It means that when all of part of the beam configurations are resumed, only the beam configuration(s) that are associated with non-expired TATs can be resumed.

The above description of the invention is made from the terminal device (e.g. UE)'s perspective. From the network device (e.g. gNB)'s perspective, the gNB transmits the message (e.g. one of the paging message, the short message, the short messages indicator, the new broadcast message, a new RRC message and a new message on Uu interface) including the paging for MT-SDT. Afterwards, depending on the UE's determination, one of an RA-SDT, an CG-SDT and a legacy RACH procedure is determined as the DL data receiving procedure for MT SDT. Accordingly, the gNB receives a first message of one of an RA-SDT, an CG-SDT and a legacy RACH procedure, wherein the first message indicates which one of the RA-SDT, the CG-SDT and the legacy RACH procedure is determined as the DL data receiving procedure for MT SDT.

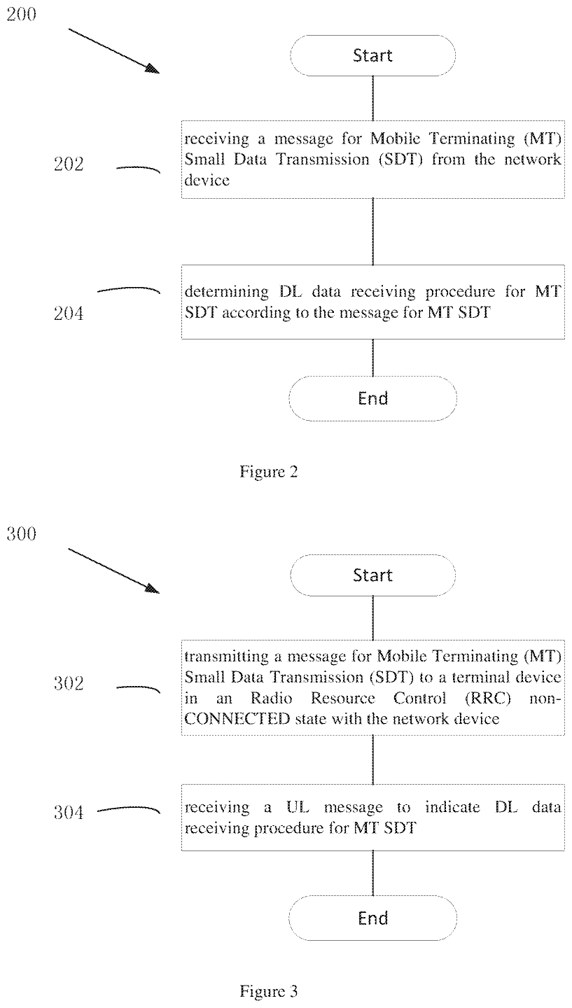

FIG. 2 is a schematic flow chart diagram illustrating an embodiment of a method 200 according to the present application. In some embodiments, the method 200 is performed by an apparatus, such as a remote unit (UE). In certain embodiments, the method 200 may be performed by a processor executing program code, for example, a microcontroller, a microprocessor, a CPU, a GPU, an auxiliary processing unit, a FPGA, or the like.

The method 200 may be performed by a terminal device that supports an Radio Resource Control (RRC) non-CONNECTED state with a network device, and comprise 202 receiving a message for Mobile Terminating (MT) Small Data Transmission (SDT) from the network device; and 204 determining DL data receiving procedure for MT SDT according to the message for MT SDT.

In one embodiment, the message includes at least one of an intention indication, a responding indication and a DL data size indication, wherein the intention indication indicates that the intention of the message is MT SDT, the responding indication indicates the procedure that can be used for responding to the paging for MT-SDT, the DL data size indication indicates at least one of (1) DL data size, (2) an RSRP threshold, (3) whether the data size is larger or smaller than a data size threshold, and (4) the DL data is one-shot transmission or multiple-shot transmission.

In another embodiment, the message is one of a paging message, a short message, a short message indicator, a new broadcast message, a new RRC message and a new message on Uu interface.

In some embodiment, one of an RA-SDT, an CG-SDT and a legacy RACH procedure is determined as the DL data receiving procedure for MT SDT.

In some embodiment, determining the DL data receiving procedure for MT SDT further comprises determining resuming occasion and/or resumed configurations. The resuming occasion is one of: upon the message for MT SDT is received; upon UL responding procedure is initiated; upon UL responding message is transmitted; after RRC resume request message has been successfully received; and after UL transmission on PUSCH has been confirmed. The resumed configurations includes beam configurations, and the beam configurations are resumed according to configuration contained in the message for MT SDT from the network device, or the beam configurations are not allowed to be resumed. In some embodiment, only the beam configurations associated with non-expired TATs can be resumed. The resumed configurations may include beam configurations, where the beam configurations are released when a neighboring cell is reselected to respond to the MT SDT.

FIG. 3 is a schematic flow chart diagram illustrating a further embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may be performed by a network device and comprise 302 transmitting a message for Mobile Terminating (MT) Small Data Transmission (SDT) to a terminal device in an Radio Resource Control (RRC) non-CONNECTED state with the network device; and 304 receiving a UL message to indicate DL data receiving procedure for MT SDT.

In one embodiment, the message includes at least one of an intention indication, a responding indication and a DL data size indication, wherein the intention indication indicates that the intention of the message is MT SDT, the responding indication indicates the procedure that can be used for responding to the paging for MT-SDT, the DL data size indication indicates at least one of (1) DL data size, (2) an RSRP threshold, (3) whether the data size is larger or smaller than a data size threshold, and (4) the DL data is one-shot transmission or multiple-shot transmission.

In another embodiment, the message is one of a paging message, a short message, a short message indicator, a new broadcast message, a new RRC message and a new message on Uu interface.

In some embodiment, the UL message indicates one of an RA-SDT, an CG-SDT and a legacy RACH procedure as the DL data receiving procedure for MT SDT.

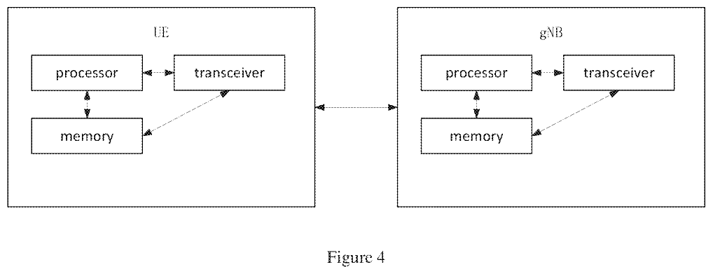

FIG. 4 is a schematic block diagram illustrating apparatuses according to one embodiment.

Referring to FIG. 4, the UE (i.e. remote unit, or terminal device) includes a processor, a memory, and a transceiver. The processor implements a function, a process, and/or a method which are proposed in FIG. 2.

The terminal device that supports an Radio Resource Control (RRC) non-CONNECTED state with a network device comprises a processor; and a transceiver coupled to the processor, wherein the processor is configured to receive, via the transceiver, a message for Mobile Terminating (MT) Small Data Transmission (SDT) from the network device; and determine DL data receiving procedure for MT SDT according to the message for MT SDT.

In one embodiment, the message includes at least one of an intention indication, a responding indication and a DL data size indication, wherein the intention indication indicates that the intention of the message is MT SDT, the responding indication indicates the procedure that can be used for responding to the paging for MT-SDT, the DL data size indication indicates at least one of (1) DL data size, (2) an RSRP threshold, (3) whether the data size is larger or smaller than a data size threshold, and (4) the DL data is one-shot transmission or multiple-shot transmission.

In another embodiment, the message is one of a paging message, a short message, a short message indicator, a new broadcast message, a new RRC message and a new message on Uu interface.

In some embodiment, one of an RA-SDT, an CG-SDT and a legacy RACH procedure is determined as the DL data receiving procedure for MT SDT.

In some embodiment, determining the DL data receiving procedure for MT SDT further comprises determining resuming occasion and/or resumed configurations. The resuming occasion is one of: upon the message for MT SDT is received; upon UL responding procedure is initiated; upon UL responding message is transmitted; after RRC resume request message has been successfully received; and after UL transmission on PUSCH has been confirmed. The resumed configurations includes beam configurations, and the beam configurations are resumed according to configuration contained in the message for MT SDT from the network device, or the beam configurations are not allowed to be resumed. In some embodiment, only the beam configurations associated with non-expired TATs can be resumed. The resumed configurations may include beam configurations, where the beam configurations are released when a neighboring cell is reselected to respond to the MT SDT.

Referring to FIG. 4, the gNB (i.e. base unit or network device) includes a processor, a memory, and a transceiver. The processors implement a function, a process, and/or a method which are proposed in FIG. 3.

The network device comprises a processor; and a transceiver coupled to the processor, wherein the processor is configured to transmit, via the transceiver, a message for Mobile Terminating (MT) Small Data Transmission (SDT) to a terminal device in an Radio Resource Control (RRC) non-CONNECTED state; and receive, via the transceiver, a UL message to indicate DL data receiving procedure for MT SDT.

In one embodiment, the message includes at least one of an intention indication, a responding indication and a DL data size indication, wherein the intention indication indicates that the intention of the message is MT SDT, the responding indication indicates the procedure that can be used for responding to the paging for MT-SDT, the DL data size indication indicates at least one of (1) DL data size, (2) an RSRP threshold, (3) whether the data size is larger or smaller than a data size threshold, and (4) the DL data is one-shot transmission or multiple-shot transmission.

In another embodiment, the message is one of a paging message, a short message, a short message indicator, a new broadcast message, a new RRC message and a new message on Uu interface.

In some embodiment, the UL message indicates one of an RA-SDT, an CG-SDT and a legacy RACH procedure as the DL data receiving procedure for MT SDT.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a message for mobile terminating (MT) small data transmission (SDT) from a network device, the UE supporting a radio resource control (RRC) non-CONNECTED state with the network device; and
determine a downlink (DL) data receiving procedure for MT SDT according to the message for MT SDT.

2. The UE of claim 1, wherein the message includes at least one of an intention indication, a responding indication and a DL data size indication, wherein the intention indication indicates that an intention of the message is MT SDT, the responding indication indicates a procedure that can be used for responding to paging for MT SDT, the DL data size indication indicates at least one of DL data size, a reference signal received power (RSRP) threshold, whether the DL data size is larger or smaller than a data size threshold, or the DL data is one-shot transmission or multiple-shot transmission.

3. The UE of claim 1, wherein the message is one of a paging message, a short message, a short message indicator, a new broadcast message, a new RRC message, or a new message on Uu interface.

4. The UE of claim 1, wherein one of a random access channel based SDT (RA-SDT), a configured grant based SDT (CG-SDT), or a legacy random access channel (RACH) procedure is determined as the DL data receiving procedure for MT SDT.

5. The UE of claim 1, wherein the at least one processor is further configured to cause the UE to determine the DL data receiving procedure for MT SDT by determining resuming occasion and/or resumed configurations.

6. The UE of claim 5, wherein the resuming occasion is one of:
upon the message for MT SDT is received;
upon Uplink (UL) responding procedure is initiated;
upon UL responding message is transmitted;
after RRC resume request message has been successfully received; or
after UL transmission on Physical Uplink Shared Channel (PUSCH) has been confirmed.

7. The UE of claim 5, wherein
the resumed configurations include beam configurations, and
the beam configurations are resumed according to configuration contained in the message for MT SDT from the network device, or the beam configurations are not allowed to be resumed.

8. The UE of claim 7, wherein only the beam configurations associated with non-expired timing adjustment timers (TATs) can be resumed.

9. The UE of claim 5, wherein
the resumed configurations include beam configurations, and
the beam configurations are released when a neighboring cell is reselected to respond to the MT SDT.

10. A base station for wireless communication, comprising:
at least one memory; and
at least one processor coupled with the at least one memory and configured to cause the base station to:
transmit a message for mobile terminating (MT) small data transmission (SDT) to a user equipment (UE) in a radio resource control (RRC) non-CONNECTED state; and
receive an uplink (UL) message to indicate a downlink (DL) data receiving procedure for MT SDT.

11. The base station of claim 10, wherein the message includes at least one of an intention indication, a responding indication and a DL data size indication, wherein the intention indication indicates that an intention of the message is MT SDT, the responding indication indicates a procedure that can be used for responding to paging for MT SDT, the DL data size indication indicates at least one of DL data size, a reference signal received power (RSRP) threshold, whether the DL data size is larger or smaller than a data size threshold, or the DL data is one-shot transmission or multiple-shot transmission.

12-15. (canceled)

16. The UE of claim 1, wherein absence of a responding indication in the message indicates that the UE is allowed to respond to paging for MT SDT with a configured grant based SDT (CG-SDT) procedure.

17. The UE of claim 1, wherein the at least one processor is further configured to cause the UE to determine a resuming occasion at which one or both of configured SDT data resource bearers (DRBs) or SDT signal resource bearers (SRBs) are resumed according to the message for MT SDT.

18. A processor for wireless communications, the processor comprising:
at least one controller coupled with at least one memory and configured to cause the processor to:
receive a message for mobile terminating (MT) small data transmission (SDT) from a network device, the processor supporting a radio resource control (RRC) non-CONNECTED state with the network device; and
determine a downlink (DL) data receiving procedure for MT SDT according to the message for MT SDT.

19. The processor of claim 18, wherein the message includes at least one of an intention indication, a responding indication and a DL data size indication, wherein the intention indication indicates that an intention of the message is MT SDT, the responding indication indicates a procedure that can be used for responding to paging for MT SDT, the DL data size indication indicates at least one of DL data size, a reference signal received power (RSRP) threshold, whether the DL data size is larger or smaller than a data size threshold, or the DL data is one-shot transmission or multiple-shot transmission.

20. The processor of claim 18, wherein the message is one of a paging message, a short message, a short message indicator, a new broadcast message, a new RRC message, or a new message on Uu interface.

21. The processor of claim 18, wherein absence of a responding indication in the message indicates that the processor is allowed to respond to paging for MT SDT with a configured grant based SDT (CG-SDT) procedure.

22. The processor of claim 18, wherein the at least one controller is further configured to cause the processor to determine a resuming occasion at which one or both of configured SDT data resource bearers (DRBs) or SDT signal resource bearers (SRBs) are resumed according to the message for MT SDT.

23. A method performed by a user equipment (UE) that supports a radio resource control (RRC) non-CONNECTED state with a network device, the method comprising:
receiving a message for mobile terminating (MT) small data transmission (SDT) from a network device, the UE supporting a radio resource control (RRC) non-CONNECTED state with the network device; and
determining a downlink (DL) data receiving procedure for MT SDT according to the message for MT SDT.

24. The method of claim 23, wherein the message includes at least one of an intention indication, a responding indication and a DL data size indication, wherein the intention indication indicates that an intention of the message is MT SDT, the responding indication indicates a procedure that can be used for responding to paging for MT SDT, the DL data size indication indicates at least one of DL data size, a Reference Signal Received Power (RSRP) threshold, whether the DL data size is larger or smaller than a data size threshold, or the DL data is one-shot transmission or multiple-shot transmission.
